(19) United States
(12) Patent Application Publication
(10) Pub. No.: US 2009/0313536 A1
(43) Pub. Date: Dec. 17, 2009

(54) Dynamically Providing Relevant Browser Content

(75) Inventors: Ron Karidi, Herzeliya (IL); Eran Yariv, Zichron Yaakov (IL); Roy Varshavsky, Tel Aviv (IL); Daniel Sitton, Tel Aviv (IL); Oded Elyada, Hod-Hasharon (IL); Noga Amit, Tel Aviv (IL); Omer Ramote, Ramat-Gan (IL)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 12/136,889

(22) Filed: Jun. 11, 2008

(51) Int. Cl. G06F 17/00

(52) U.S. Cl. 715/209

(57) ABSTRACT

A requested content page is provided with additional relevant content that is dynamically generated. A page originally requested by a browser application is generated and examined to determine key words, address information, and other information for which relevant content may be retrieved. The other information may not be part of the original page content, but it can be the relation between the content page and other pages. The relevant content is determined based on the results of the content page examination. After retrieving the relevant content, the retrieved content is embedded into the requested content page and provided to the requesting user. The retrieved relevant content may be provided with the requested content page in a designated portion within the requested content page, near related content in the page, and/or displayed in response to user input as a pop-up window or in a preview pane. Relevant content can be determined, retrieved and embedded in a content page by a relevant content engine implemented as a server application, client application or browser application plug-in.

### BACKGROUND

Browsing content over the Internet typically involves providing input to a web browser application and the application retrieving a web page in response to the input. The input can be selection of a web link for another web page, selection of a button on a web page, or some other input that requires the web browser to retrieve a web page over the Internet. Typically, the web browser application only provides the requested web content to a user through the browser interface.

Some web content providers generate web pages that provide previews of content from other web pages provided by that provider. The web page provider may provide a first web page and a second web page that may be accessed separately. The first web page may list a number of links to other web pages provided by the same provider, including a web link to the second web page. For example, some web-based new services provide a first web page with a list of links associated with different news stories. Each link in the first web page may be expressed as text comprising a news headline. When a user positions a cursor over the headline link, a text box may appear near the link. The text box may include a portion of the article contained on a second web page and associated with the link headline. Thus, by placing a cursor over the headline link in the first page, it appears that a portion of the story contained in the second web page appears in a pop-up box near the headline selected.

Text boxes providing a preview of content from a second web page and provided in response to positioning a cursor over a link are generally static in nature and hard coded within the first web page. This requires that the content provider have programmers who program the content of the text box so that it appears it is a preview from a different page. The text box content and other static links or manually fed feeds provided by the web service provider is not determined dynamically. Rather, the text box content is coded into the first web page to correspond to the content in a second web page for which it is supposed to provide a preview.

### SUMMARY

The technology described herein pertains to providing a requested content page with additional relevant content that is dynamically generated. A page originally requested by a browser application, either in response to user input or some other browsing event, is generated and examined. In some embodiments, the examination may include parsing of the requested content page to determine key words, address information, and other information for which relevant content may be retrieved. The relevant content is determined based on a wide set of attributes, including the results of the content page examination and other content, connectivity and user behavior statistics. After retrieving the relevant content, the retrieved content is embedded into the requested content page and provided to the requesting user.

The retrieved relevant content may be provided to a user in several ways. For example, the retrieved relevant content may be provided with the requested content page in a designated portion within the requested content page, in the content page near related content, displayed in response to user input as a pop-up window or in a preview pane, or in some other manner. These embodiments are intended as examples, and other methods for providing the retrieved relevant content are possible and considered within the scope of the present technology. Relevant content can be determined and retrieved by a relevant content engine implemented as a server application, client application or browser application plug-in.

An embodiment provides a content page in response to receiving a request for content page data. The content page is parsed to generate parse results. Relevant content is then retrieved which is associated with selected portions of the parse results. Data associated with the relevant content is then embedded in the received content page information. After embedding the data, the content page is provided with the embedded relevant content data to a client device.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a block diagram of an embodiment of a system for providing relevant content within a content page using a server application.

FIG. 2 illustrates a block diagram of an embodiment of a system for providing relevant content within a content page using a browser plug-in.

FIG. 3 illustrates a block diagram of an embodiment of a system for providing relevant content within a content page using a client application.

FIG. 4 illustrates a flowchart of an embodiment of a method for providing relevant content with a requested content page.

FIG. 5 illustrates a flowchart of an embodiment of a method for retrieving relevant content.

FIG. 6 illustrates a flowchart of an embodiment of a method for retrieving content associated with key words.

FIG. 7 illustrates a flowchart of an embodiment of a method for embedding relevant content into a content page.

FIG. 8 illustrates a flowchart of an embodiment of another method for embedding relevant content in a content page.

FIG. 9 illustrates an example of a content page without additional relevant content.

FIG. 10A illustrates an example of a content page provided with embedded relevant content.

FIG. 10B illustrates another example of a content page provided with embedded relevant content.

FIG. 11 illustrates an embodiment of a computing environment for implementing the present technology.

### DETAILED DESCRIPTION

The present technology, roughly described, provides a requested content page with additional relevant content that is dynamically generated. A page originally requested by a browser application, either in response to user input or some other browsing event, is generated and examined. In some embodiments, the examination may include parsing of the requested content page to determine key words, address information, and other information for which relevant content may be retrieved. The relevant content is determined based on the results of the content page examination. After retrieving the relevant content, the retrieved content is embedded into the requested content page and provided to the requesting user.

The retrieved relevant content may be provided with the requested content page in several different ways. In some embodiments, the relevant content is positioned in a designated portion within the requested content page. For example, the retrieved relevant content may be provided within a frame positioned at the bottom, side, or some other position within the requested content page. In some embodiments, the relevant content may be positioned in a content page near the related content. For example, for a content page that includes an address somewhere in the page, relevant content consisting of a map may be provided in the vicinity of where the address (the related content) is displayed in the page. In some embodiments, the relevant content is not initially displayed in the content page, but is displayed in response to user input. For example, the relevant content may be provided in a preview pane in response to receiving a mouse over input associated with the related content, as a pop-up window in text box or a new page, or in some other manner in response to user input. In any case, the content in the original web page for which relevant content exists may be highlighted or otherwise marked within a requested content page to indicate that additional relevant content is available for that element. These embodiments for providing relevant content are intended as examples, and other methods for providing the retrieved relevant content are possible and considered within the scope of the present technology.

Relevant content can be determined and retrieved by a relevant content engine. The relevant content engine may be implemented on a server or client, distributed over several machines and/or devices, or be implemented in some other way. When implemented on a server, the relevant content engine is implemented as an application residing on the server and may communicate with a remote browser application, other servers, and other hardware and software. When the engine is implemented on the client, it may be implemented as a browser application plug-in, a client application, or in some other manner and communicate with a client browser application and one or more remote servers over a network.

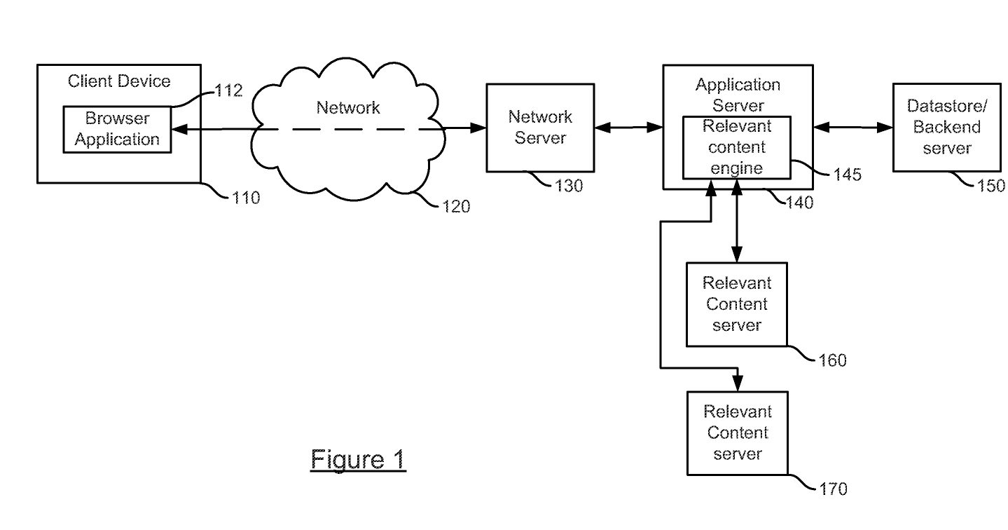

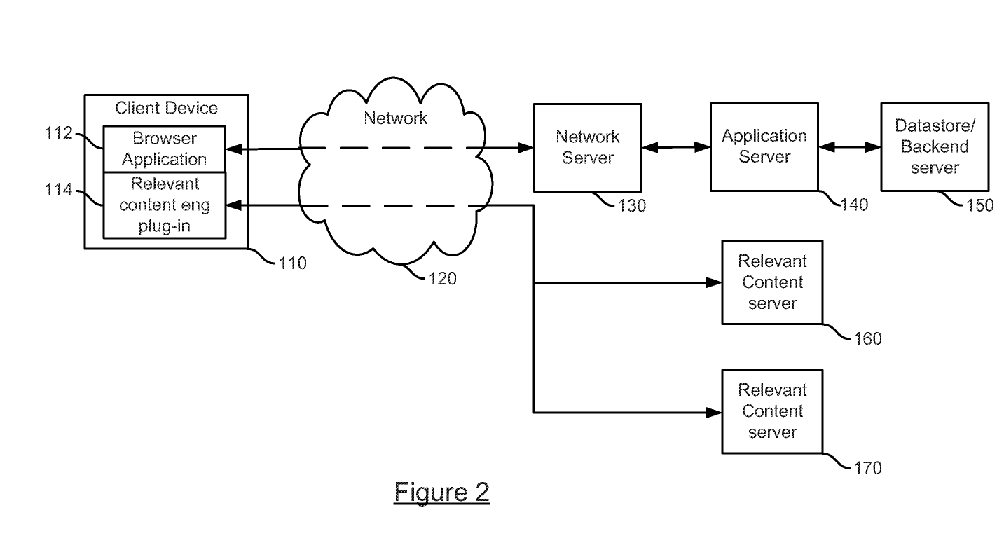

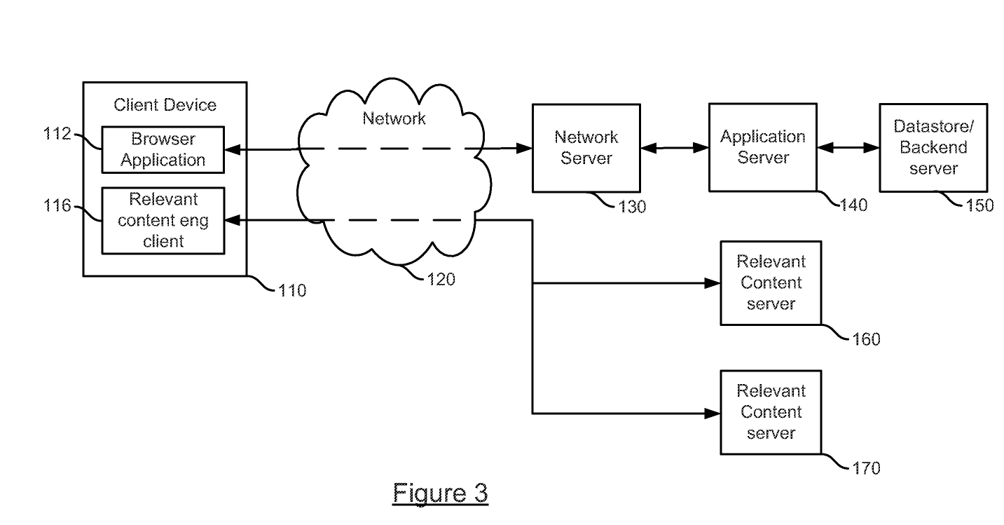

FIGS. 1-3 illustrate several embodiments of systems for retrieving and embedding relevant content in a requested content page. One differentiation between FIGS. 1-3 is the implementation of the code, or relevant content engine, which retrieves and embeds the relevant content. In particular, FIG. 1 illustrates a system with the relevant content engine implemented on a server, FIG. 2 illustrates the engine implemented as a browser plug-in on a client, and FIG. 3 illustrates the engine implemented as a client application on a client. FIGS. 1-3 are discussed in more detail below.

FIG. 1 illustrates a block diagram of an embodiment of a system for providing relevant content for a content page. The system of FIG. 1 includes client device 110, network 120, network server 130, application server 140, data store 150 and relevant content servers 160 and 170.

Client device 110 is a computing device that communicates with one or more servers such as network server 130 over network 120 and includes browser application 112. Browser application 112 may retrieve content pages from a network server, provide an interface, provide content pages in the interface and receives input through the interface. In some embodiments, browser application 112 may be provided as “Internet Explorer” by Microsoft Corporation of Redmond, Wash.

Network 120 may be implemented as a private or public network, such as the Internet, an intranet, a WAN, a LAN, extranet, a combination of these networks or other network or networks. Client application 110 and network server 130 may communicate over network 120, which may be implemented as the web.

Network server 130 provides content pages, such as a web page, and/or content page data to requesting client devices as part of a network service, such as a web service, and communicates with client 110 over network 120 and application server 140. In some embodiments, when network 120 is implemented as the Internet, network server 130 may be implemented as a web server. In any case, network server 130 may provide content pages to browser application 112 on client 110 and may be implemented as one or more servers.

Application server 140 communicates with network server 130 and data store 150 and includes relevant content engine 145. Application server 140 may be invoked by network server 130 to generate at least a portion of requested content page. In response, application server may generate at least a portion of the content page and/or invoke one or more data stores and/or other backend servers to generate data for the content page. Application server may include one or more applications and comprise one or more servers.

Relevant content engine 145 may access content pages to be sent to browser application 112 through network server 130 and network 120. After accessing a content page, engine 145 may analyze and modify the content page to include additional relevant content within the page. The relevant content added to a content page by relevant content engine 145 is dynamically determined and added to the content page to be displayed in response to user input or not.

Relevant content engine 145 may include code and/or other program instructions that may analyze and modify a requested content page. In particular, content engine 145 may examine and/or parse a content page provided to a client, detect key words, address and location information, stock symbols and other stock data, links to other content pages and other information in a content page as a result of the parsing or examination, retrieve content relevant to selected parsing results and embed the relevant content into the original content page. After content engine 145 analyzes and modifies a requested content page, the modified content page is eventually provided to requesting client 110 by application server 140 and sent to client device 110. This is discussed in more detail below.

In some embodiments, at least a portion of the relevant content added to a requested content page by relevant content engine 145 will be from a network provider or network service other than that associated with network server 130 or application server 140. For example, each of relevant content servers 160-170 may have a different domain (and be associated with a different network service provider) than application server 140 and network server 130. Relevant content engine 145 may retrieve data from relevant content servers 160 or 170, each of which may perform services to provide content to a requesting engine. The service may include providing a map from an address or location provided, perform general Internet searches for information related to a key word provided by engine 145, determine musician and album information for a particular song title, determine a current stock price and other information for a stock symbol, and other services which provide relevant content to a requesting engine.

Data store 150 may be implemented as any back-end server that provides a content page requested by a user. Data store 150 may communicate with application server 140.

FIG. 2 illustrates a block diagram of an embodiment of a system for providing relevant content within a content page using a browser plug-in. The system of FIG. 2 includes client device 110, network 120, network server 130, application server 140, data store 150, and relevant content servers 160 and 170 similar to the system of FIG. 1.

Client device 110 includes browser application 112 and relevant content engine plug-in 114. Relevant content engine plug-in 114 is a plug-in for use with browser application 112 and performs similar functions as relevant content engine 145 discussed above with respect to FIG. 1. In particular, relevant content engine plug-in 114 may be implemented as code and/or program instructions that may analyze (for example parse) a requested content page, retrieve additional content that is relevant to the requested content page, and embed the content in the requested content page. Plug-in 114 may then provide the requested content page and relevant content to a user. Unlike relevant content engine 145, relevant content engine plug-in 114 analyzes a content page after it has been provided to client device 110 rather than after it has been created by an application on application server 140.

FIG. 3 illustrates a block diagram of an embodiment of a system for providing relevant content within a content page using a client application. The system of FIG. 3 includes client device 110, network 120, network server 130, application server 140, data store 150 and relevant content servers 160 and 170.

Unlike the systems of FIGS. 1 and 2, the system of FIG. 3 includes a relevant content engine 116 implemented as client application 116 on client 100. Similar to engines 145 and 114, relevant content engine client 116 may analyze a requested content page, retrieve relevant content, and modify the requested content page to add or otherwise provide relevant content to a user.

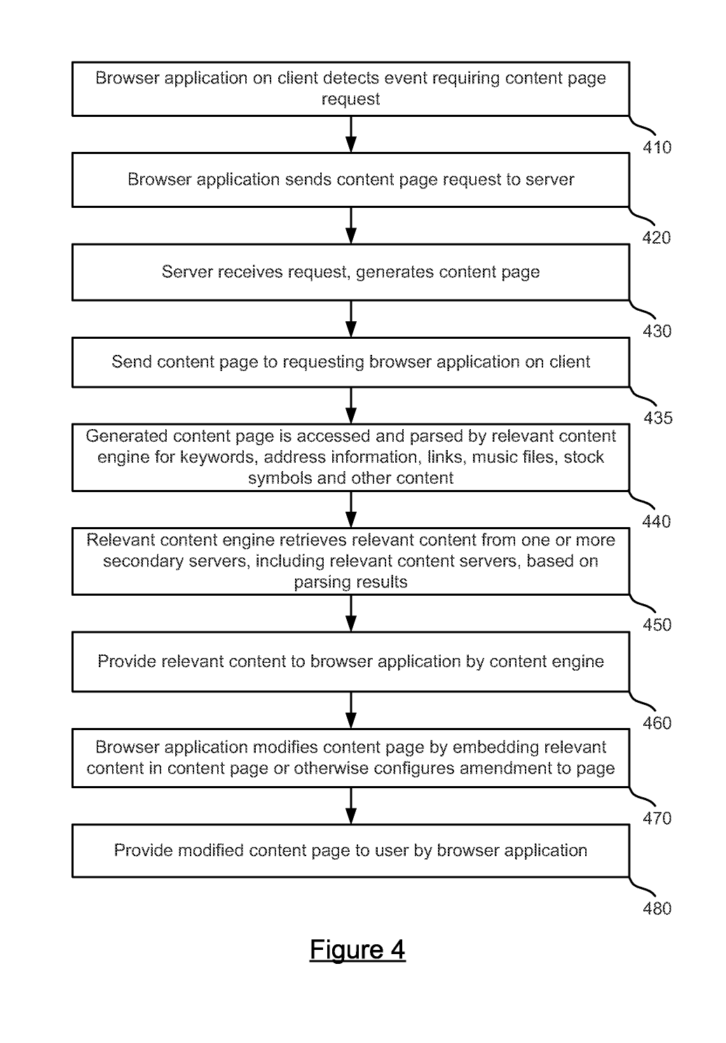

FIG. 4 illustrates a flow chart of an embodiment of a method for providing relevant content with a requested content page. First, browser application 112 on client 110 detects an event requiring a content page request. The event may comprise a user initiated event, such as receiving a selection of a button, a link, or other content page element by a user or receiving input from a user into the content page. In some embodiments, the detected event may not be associated with a user, such as for example the expiration of a timer, a received update notification, or some other event.

Browser application 112 sends a content page request to network server 130 over network 120 in response to detecting the event at step 420. After receiving the request, application server 140 generates a content page in response to the request at step 435. To generate the content page, application server 140 may invoke data store 150 or some other server to process at least a portion of the request. The content page generated by application server 140 is that which was requested at step 420.

The generated content page is transmitted to a requesting client device at some point at step 435. The content page may be sent immediately after generating the content page at step 430 (after which the content page is processed by one of relevant content engines 114 or 116 located on client 110) or after the page is processed by content engine 145. Thus, the point in the process at which the content page is sent to client device 110 depends on the location of the relevant content engine code.

The generated content page is accessed and parsed by a relevant content engine for key words, address information, links, music files, stock symbols, and other content at step 440. In some embodiments, key words may be nouns or subjects appearing in sentences, words that appear two or more times in a sentence or other group of text, or some other word detected as a key word. In some embodiments, key words may be detected by any of several algorithms for detecting key words in a group or text or within a web page which are well known in the art. Content such as addresses may be detected as numbers followed by text which includes recognized words such as street, avenue, boulevard, or some other recognized address label. Several algorithms exist for detecting key words, addresses, music files, and stock symbols, all of which may be used in accordance with the present technology.

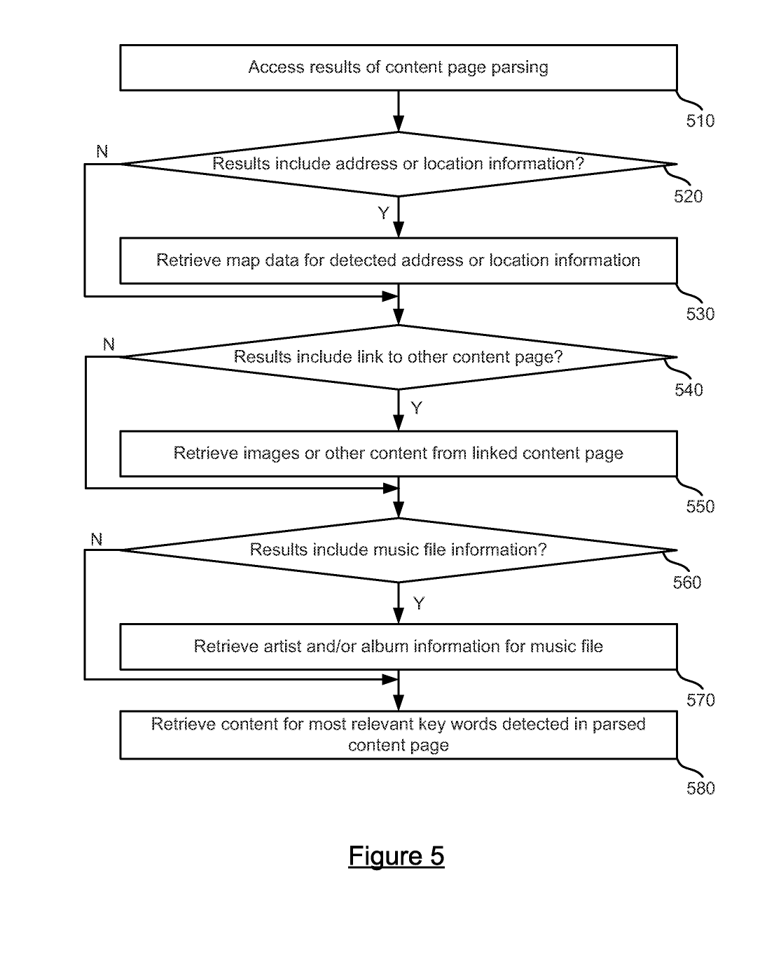

After parsing the generated content page, a relevant content engine retrieves relevant content from one or more remote servers, such as for example relevant content servers 160 and 170, based on the parsing results at step 450. The relevant content engine may retrieve several types of relevant content from the servers, including map data, Internet content associated with a key word, images contained on linked pages, stock prices, and other data. Retrieving relevant content from one or more relevant content servers is discussed in more detail below with respect to FIG. 5.

A content engine provides relevant content to browser application 112 at step 460. The relevant content page may be provided to browser application 112 by relevant content engine 145 on application server 140, relevant content engine client 116 or plug-in 114.

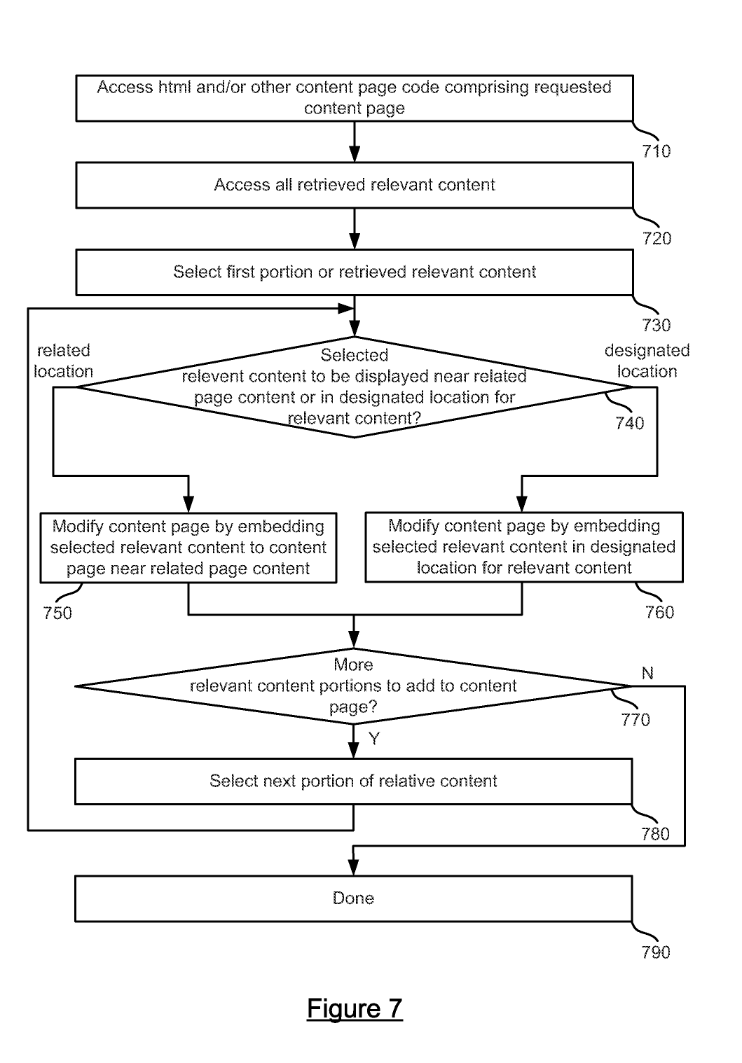

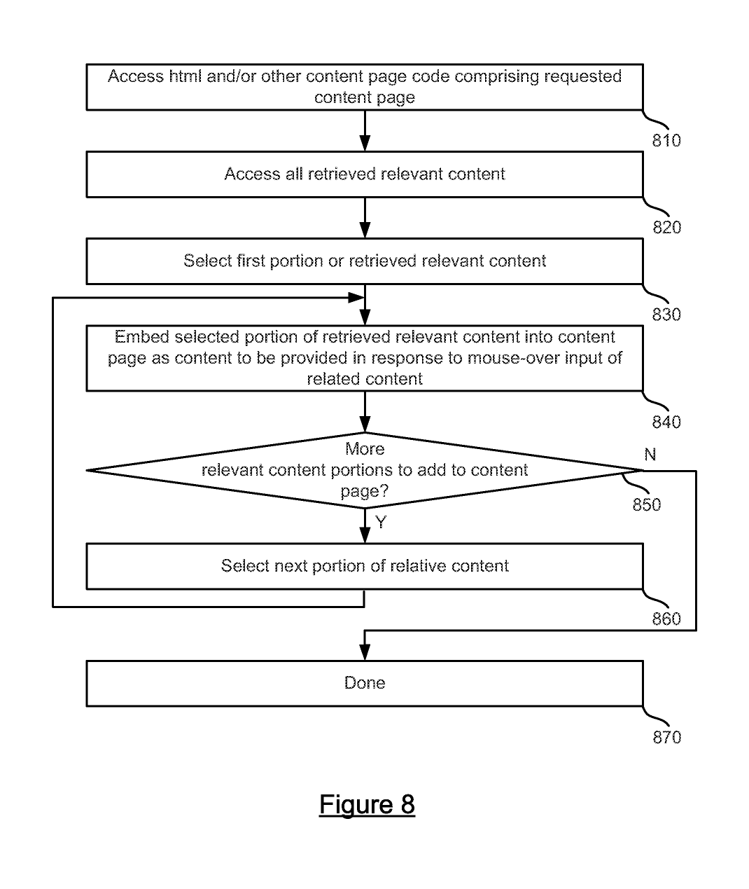

Browser application 112 may modify the content page by embedding the relevant content into the content page, or otherwise provides the relevant content as an amendment to or addendum to the original page, at step 460. In some embodiments, relevant content is embedded to display within the content page automatically in response to receiving the request for the content page by browser application 112. In some embodiments, the relevant content is embedded and displayed in response to user input received through the browser application, such as when the user positions a cursor over a content page element related to the relevant content. Modifying a content page to embed relevant content in the page is discussed in more detail below with respect to FIGS. 7 and 8.

The browser application provides the content page and relevant content to a user through a browser interface at step 480. As discussed above, the relevant content may be embedded within the content page, provided as an addendum, or in some other manner. The relevant content itself may be initially provided within the content page or in response to user input (or an internal event) received through the

FIG. 5 illustrates a flow chart of an embodiment of a method for retrieving relevant content. In some embodiments, the method of FIG. 5 provides more detail for step 450 of the method of FIG. 4. First, results of the content page parsing are accessed at step 510. The results are those generated in response to the parsing performed at step 440 of the method of FIG. 4. The parsing results may include a list of addresses, key words, stock symbols, links, and other content for which relevant content can be retrieved. Next, a determination is made as to whether the parsing results include address or location information at step 520. For example, a determination is made as to whether a street number and street name are detected, an airport name is detected, a landmark is contained within the parse results, for example such as Yellowstone National Park, or some other text that is recognized as being associated with an address or a location. If the results do not include an address or location information, the method of FIG. 5 continues to step 540. If the results do include an address or location information, the appropriate relevant content engine retrieves map data for the detected address or location information at step 530. The retrieved map data may include directions from a default address to the location, a thumbnail or other image of a map of the address or location, or some other map data associated with the detected address or location. After retrieving map data at step 530, the method of FIG. 5 continues to step 540.

A determination is made as to whether the parsing results include a link to another content page at step 540. If the results do not include links to any other content pages, the method of FIG. 5 continues to step 560. If the results do include a link to another content page, images from the other content page are retrieved at step 550. The retrieved images may be used to embed in the requested content page. After retrieving the images, the method of FIG. 5 continues to step 560.

A determination is then made as to whether the parsing results include music file information at step 560. Music file information may be detected by comparing phrases and/or text within the requested content page to a list of known music files. In some embodiments, a music file may be detected by recognizing the type of file, for example an MP3 file. If the parsing results indicate that music file information is contained in the requested content page, the relevant content engine may retrieve artist, album, and/or other information for the music file at step 570. The information may be retrieved by a relevant content engine from one or more relevant content servers 160-170. After retrieving information, the method of FIG. 5 continues to step 580. If the parsing results do not include music file information, the method of FIG. 5 continues to step 580.

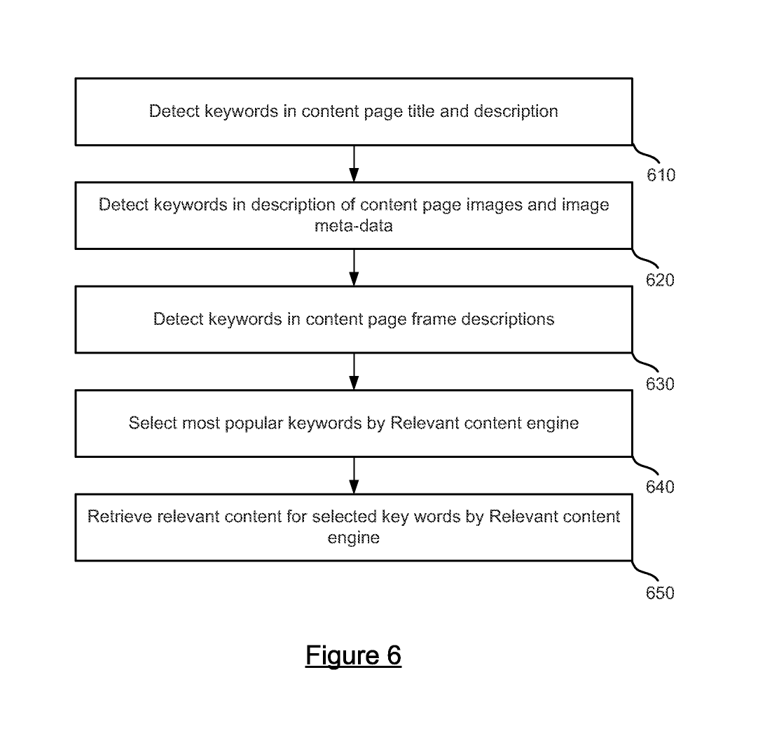

Content is retrieved for the most relevant key words detected in the parsed content page at step 580. Several methods may be used to detect a key word within the parsed content page. In some embodiments, a relevant content engine may examine the title, frame headlines, text, image metadata, and other information within the content page to determine one or more key words. Retrieving content from the most relevant key words is discussed in more detail below with respect to FIG. 6.

In some embodiments, additional information may be used to retrieve relevant information associated with a requested content page. In some embodiments, information for stock symbols, company names, or other corporate information may be used to retrieve stock data, company website information or other company data as relevant content. In some embodiments, information may be detected regarding a user currently interfacing with a browser application. The information may include identifying any applications stored on the computer, open applications, the time zone of the user, and/or other information. These are intended as examples only, and other content contained in a content page may be used as a basis to retrieve relevant content.

FIG. 6 illustrates a flow chart of an embodiment of a method for retrieving content associated with one or more key words. In some embodiments, the method of FIG. 6 provides more detail for step 580 of the method of FIG. 5. First, key words are detected in a content page title and description at step 610. The key words detected in the content page title and description may include nouns, the first words of the title and description, the subject of a sentence or phrase, or some other word. Any of several algorithms for detecting a key word or subject within a text phrase are known in the art and may be used herein with the present technology.

Key words are detected in the description of a content page image or in image metadata at step 620. The metadata may be data included in the image file which is accessed by a relevant content engine. In some embodiments, in addition to analyzing the image itself, a relevant content engine may examine descriptive text associated with the image. The descriptive text may appear as text positioned within the same frame as the image or other description information for the image. Next, key words may be detected in a content page frame description at step 630.

After detecting key words within a requested content page, the most popular key words are selected by a relevant content engine at step 640. The most popular key words may be the most relevant key words, such as key words associated with a noun, place, or other element, key words that appear in the content page more than a minimum number of times, the most common set of key words, for example the most popular three or four key words in a content page, or other key words. After selecting the most popular key words, relevant content for the selected key words is retrieved by a relevant content engine at step 650. The relevant content may include search results provided by web-based engines for the key words. The relevant content retrieved by the relevant content engine is stored locally until it is embedded into the requested content page by the engine.

FIG. 7 illustrates a flow chart of an embodiment of a method for embedding relevant content in a content page. In some embodiments, the method of FIG. 7 provides more detail for step 460 of the method of FIG. 4. First, HTML and/or other content page code comprising the requested content page is accessed at step 710. The retrieved relevant content is then accessed at step 720. A first portion of the retrieved relevant content is then selected at step 730. A first selected portion may include a first key word, a first address, or some other element of the retrieved relevant content.

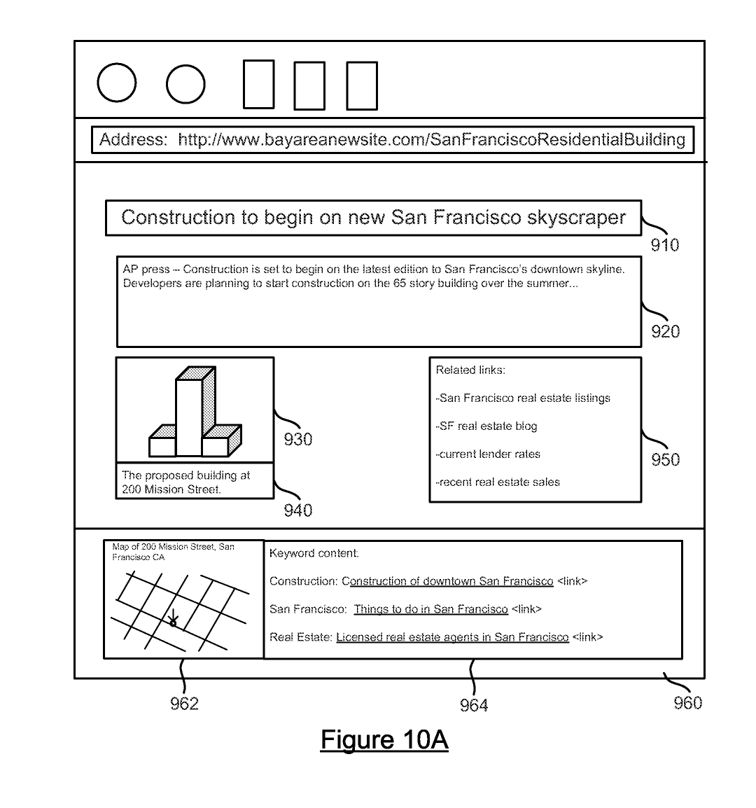

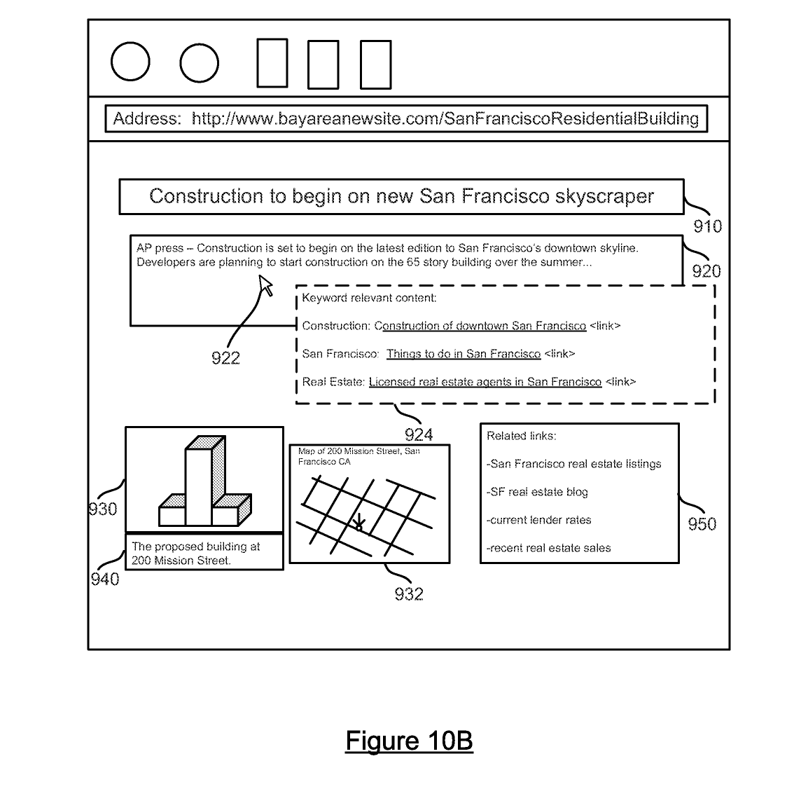

A determination is made as to whether the selected relevant content should be displayed near the related page content or in a designated location in the content page for relevant content at step 740. For example, for relevant content comprising a map, the related page content may be the address contained in the content page from which the map was generated. Determining whether or not to place the map by the pre-existing address in the content page may be based on a setting configured by a user, a service administrator, or pre-set. If the selected relevant content is to be displayed near the related page content, the method of FIG. 7 continues to step 750. If the selected relevant content is to be displayed in a designated location for relevant content in the content page, the content page is modified by embedding the selected relevant content in the designated location in the page at step 760. For example, FIG. 10A illustrates a modified content page. Map 962 and key word content 964 are placed in a frame 960 associated with relevant content. After modifying the content page at step 760, the method of FIG. 7 continues to step 770.

When placing relevant content portions near related content in a content page, the content page is modified by embedding the selected relevant content in the content page at a location near the related content at step 750. For example, with respect to FIG. 10B, relevant content map 932 is positioned next to related content image 930 and image heading 940 which describe the address associated with the map. After modifying the content page to embed relevant content next to its related content, the method of FIG. 7 continues to step 770.

A determination is made as to whether more relevant content portions exist to be added to the content page at step 770. This determination identifies whether there are more maps, key word content, stock data or other relevant content to add to the content page. If no additional relevant content exists to be added, the method of FIG. 7 is complete at step 790. If more relevant content exists to be embedded in the content page, the next portion of relevant content is selected at step 780 and the method of FIG. 7 returns to step 740.

FIG. 8 illustrates a flow chart of an embodiment of another method for embedding relevant content in a content page. The method of FIG. 8 provides another example of implementing step 460 of the method of FIG. 4. Steps 810-830 are similar to steps 710-730 of the method of FIG. 7. In particular, HTML and/or other content page code are accessed at step 810 and retrieved relevant content is accessed at step 820.

A first portion of the retrieved relevant content is then selected at step 830. A selected portion of the retrieved relevant content is then embedded into the content page as content to be provided in response to a mouse-over input for the related content at step 840. Thus, instead of embedding the relevant content within a portion of the content page to be displayed with all the other content, the relevant content is embedded in the content page in such a manner as to only be displayed in response to a particular input, such as mouse-over input. For example, the interface of FIG. 10B illustrates key word content 924. The key word content 924 is only illustrated when a cursor 922 is positioned over text box 920 within the interface. This is the primary difference between the methods of FIG. 8 and FIG. 7.

After embedding the selected portion of relevant content into the content page, a determination is made as to whether more relevant content portions exist to be added to the content page at step 850. If additional relevant content portions exist to be added, the next portion of relevant content is added at step 860 and the method of FIG. 8 returns to step 840. If no additional relevant content portions exist to be added, the method of FIG. 8 is complete at step 870.

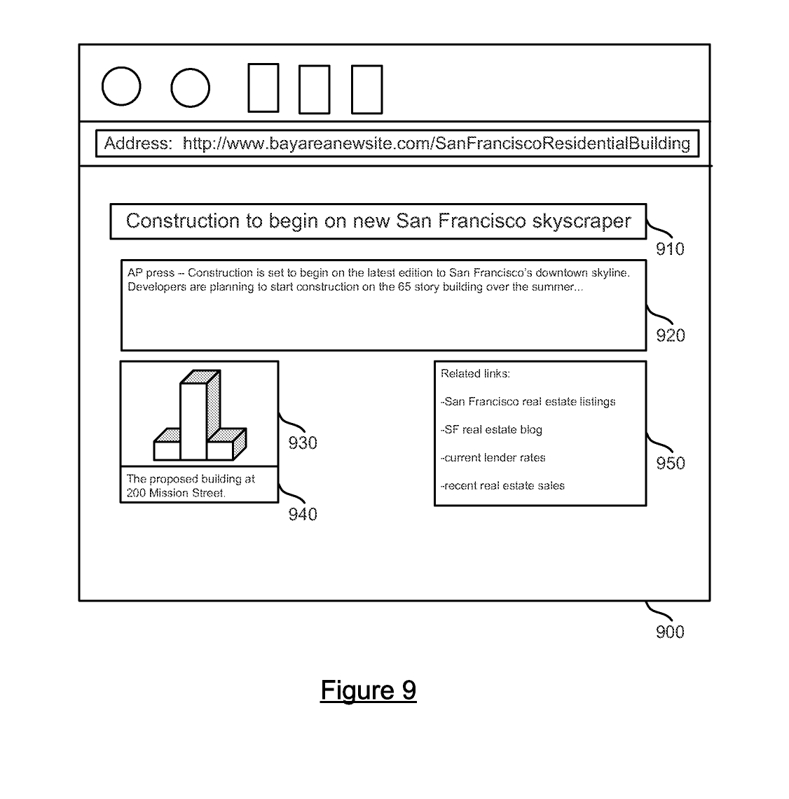

FIG. 9 illustrates an example of a content page without additional relevant content. In some embodiments, the content page of FIG. 9 is provided by browser application 112 of client device 1110. Content page 900 of FIG. 9 includes heading 910, text content 920, image 930, image heading 940, and a related links frame 950. The heading 910 includes text which reads “Construction to Begin on New San Francisco Skyscraper.” Text portion 920 includes text that reads “AP Press—Construction is set to begin on the latest edition to San Francisco's downtown skyline. Developers are planning to start construction on the 65 story building over the summer . . . .” Image 930 illustrates an image of a building. Image description box 940 includes text which reads “The proposed building at 200 Mission Street.”

The related links frame 950 includes a list of links associated with construction, San Francisco real estate, and other real estate information. Any of the relevant content engines of FIGS. 1-3 may parse the code used to provide content page 900 to determine key words in heading 910, text box 920, and image description 940, identify addresses contained in image box 940, and detect other data and information from which relevant data can be retrieved.

FIG. 10A illustrates an example of a content page provided with embedded relevant content. The content page of FIG. 10A is similar to that of FIG. 9 except that the content page of FIG. 10A includes a dedicated relevant content frame 960. The relevant content within frame 960 includes map 962 and key word relevant content 964. Map 962 is a map of the address “200 Mission Street” included in image heading 940. The key word content 964 includes links to web pages associated with three key words, “construction,” “San Francisco,” and “real estate.” Associated with each key word is a link to a web page with more information associated with the corresponding key word.

FIG. 10B illustrates another example of a content page provided with embedded relevant content. The content page of FIG. 10B is similar to that of FIG. 10A except for how the relevant content is provided within the content page. For example, a map of “200 Mission Street” is provided in the vicinity of an image and image heading within the original content page rather than in a dedicated relevant content frame as in FIG. 10A. Similarly, key word relevant content 924 is provided in the vicinity of text box 920 rather than within dedicated relevant content portion 960. Additionally, key word relevant content 924 is provided when a cursor 922 is positioned over text box 920. This is indicated by the dash line comprising key word relevant content 924 in FIG. 10B.

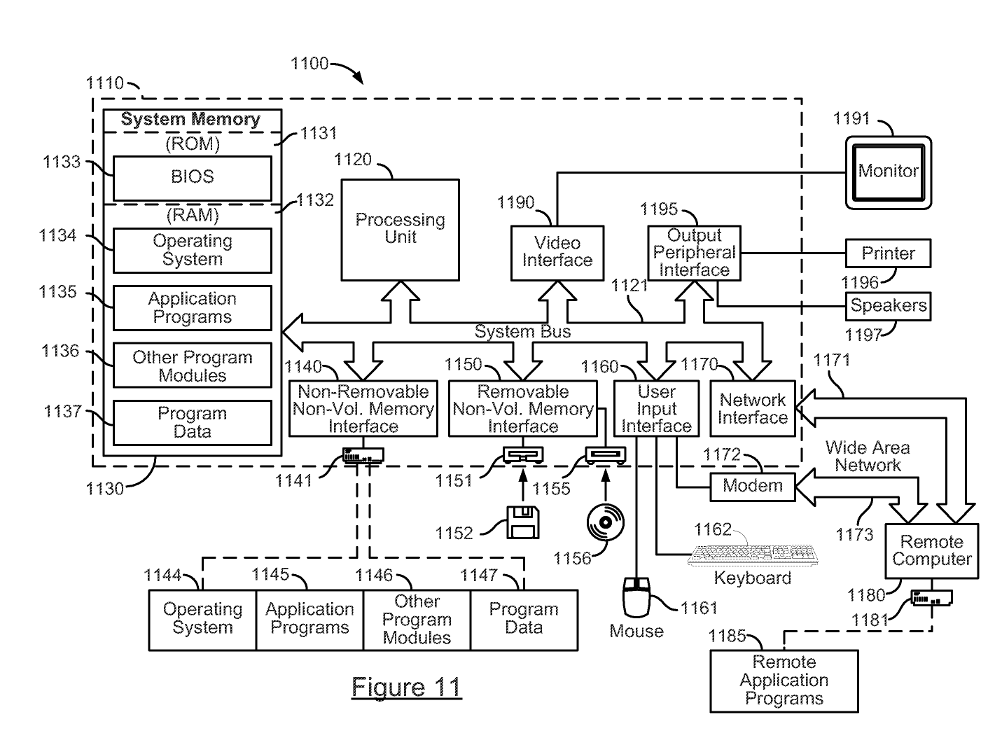

FIG. 11 illustrates an embodiment of a computing environment for the present technology. The environment of FIG. 11 may be used to implement each of client device 110, network server 130, application server 140, data store 150, and relevant content servers 160-170.

Computing environment 1100 of FIG. 11 is only one example of a suitable computing environment and is not intended to suggest any limitation as to the scope of use or functionality of the technology herein. Neither should the computing environment 1100 be interpreted as having any dependency or requirement relating to any one or combination of components illustrated in the exemplary operating environment 1100.

The technology described herein is operational with numerous other general purpose or special purpose computing system environments or configurations. Examples of well known computing systems, environments, and/or configurations that may be suitable for use with the technology herein include, but are not limited to, personal computers, server computers, hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

With reference to FIG. 11, an exemplary system for implementing the technology herein includes a general purpose computing device in the form of a computer 1110. Components of computer 1110 may include, but are not limited to, a processing unit 1120, a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1110 typically includes a variety of computer readable media. Computer readable media can be any available media that can be accessed by computer 1110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1130 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable, volatile/nonvolatile computer storage media. By way of example only, FIG. 11 illustrates a hard disk drive 1140 that reads from or writes to non-removable, nonvolatile magnetic media, a magnetic disk drive 1151 that reads from or writes to a removable, nonvolatile magnetic disk 1152, and an optical disk drive 1155 that reads from or writes to a removable, nonvolatile optical disk 1156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through a non-removable memory interface such as interface 1140, and magnetic disk drive 1151 and optical disk drive 1155 are typically connected to the system bus 1121 by a removable memory interface, such as interface 1150.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. Operating system 1144, application programs 1145, other program modules 1146, and program data 1147 are given different numbers here to illustrate that, at a minimum, they are different copies. A user may enter commands and information into the computer 110 through input devices such as a keyboard 1162 and pointing device 1161, commonly referred to as a mouse, trackball or touch pad. Other input devices (not shown) may include a microphone, joystick, game pad, satellite dish, scanner, or the like. These and other input devices are often connected to the processing unit 1120 through a user input interface 1160 that is coupled to the system bus, but may be connected by other interface and bus structures, such as a parallel port, game port or a universal serial bus (USB). A monitor 1191 or other type of display device is also connected to the system bus 1121 via an interface, such as a video interface 1190. In addition to the monitor, computers may also include other peripheral output devices such as speakers 1197 and printer 1196, which may be connected through an output peripheral interface 1190.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include a local area network (LAN) 1171 and a wide area network (WAN) 1173, but may also include other networks. Such networking environments are commonplace in offices, enterprise-wide computer networks, intranets and the Internet.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. The modem 1172, which may be internal or external, may be connected to the system bus 1121 via the user input interface 1160, or other appropriate mechanism. In a networked environment, program modules depicted relative to the computer 1110, or portions thereof, may be stored in the remote memory storage device. By way of example, and not limitation, FIG. 11 illustrates remote application programs 1185 as residing on memory device 1181. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for providing a content page, comprising:
receiving a request for content page data;
generating content page information in response to the request;
parsing the received content page information to generate parse results;
retrieving relevant content associated with selected portions of the parse results;
embedding data associated with the relevant content in the received content page information; and
providing the content page with the embedded relevant content data to a client device.

2. The method of claim 1, wherein the request for the content page data is received from a remote client by a server

3. The method of claim 1, wherein the received content page information is parsed for one or more keywords.

4. The method of claim 1, wherein the received content page information is parsed for at least one of stock symbols, address information or music files.

5. The method of claim 1, wherein said step of retrieving relevant content includes:
retrieving relevant content from a remote server by a content engine residing on an application server.

6. The method of claim 1, wherein said step of embedding data includes:
embedding the retrieved relevant content in a position in the content page designated for relevant content.

7. The method of claim 1, wherein said step of embedding data includes:
embedding the retrieved relevant content in a position in the content page near content related to the relevant content.

8. The method of claim 7, wherein relevant content comprising a map image is positioned in the content page near related content comprising an address, the map image illustrating a location for the address.

9. The method of claim 1, wherein said step of embedding data includes:
embedding the retrieved relevant content in the content page code such that the relevant content is provided in response to receiving mouse-over input by a browser application providing the content page.

10. One or more processor readable storage devices having processor readable code embodied on said processor readable storage devices, said processor readable code for programming one or more processors to perform a method comprising:
accessing a content page provided by a first server over a network;
parsing the accessed content page to detect keyword information;
retrieving content relevant to the detected keyword information, the relevant content retrieved from a second server, the first server and second server provided by different application providers;
embedding the retrieved content in the accessed content page; and
providing the content page with the embedded retrieved keyword content.

11. The one or more processor readable storage devices of claim 10, wherein said step of accessing includes:
requesting the content page from the first server by a browser application on a client device.

12. The one or more processor readable storage devices of claim 10, wherein said step of parsing the accessed content page includes:
parsing the content page to detect at least one of address data and stock symbols.

13. The one or more processor readable storage devices of claim 10, wherein said step of retrieving content includes:
retrieving content from a remote server by a client application on the client device.

14. The one or more processor readable storage devices of claim 10, wherein said step of retrieving content includes:
retrieving content from a remote server by a browser application plug-in on the client device.

15. The one or more processor readable storage devices of claim 10, wherein said step of embedding includes:
embedding the retrieved relevant content in the content page to be displayed automatically by a browser application.

16. The one or more processor readable storage devices of claim 10, wherein said step of embedding includes:
embedding the retrieved relevant content in the content page to be displayed in response to receiving user input into the content page.

17. A system for providing a content page, comprising:
a relevant content engine,
the relevant content engine accessing a network browser content page, parsing the content page, retrieving content relevant to the content page and embedding the retrieved relevant content in the content page; and
one or more relevant content servers,
the one or more relevant content servers providing relevant content in response to a request received from the relevant content engine, each of the one or more relevant content servers located remote from the relevant content engine.

18. The system of claim 17, wherein said relevant content engine is implemented as an application on an application server, the application server processing a request for the content page from a client device.

19. The system of claim 17, wherein said relevant content engine is implemented as an client application on a client device, the client including a browser application which requests the content page from a remote server.

20. The system of claim 17, wherein said relevant content engine is implemented as an network browser plug-in on a client device, the plug-in communicating with a browser application which requests the content page from a remote server.
